(19) United States
(12) Patent Application Publication
(10) Pub. No.: US 2007/0102458 A1
(43) Pub. Date: May 10, 2007

(54) Spray gun for dispensing precise small liquid volumes

(75) Inventor: Brian Valley, Wheaton, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 11/594,394

(22) Filed: Nov. 8, 2006

Related U.S. Application Data
(60) Provisional application No. 60/735,497, filed on Nov. 10, 2005.

(51) Int. Cl. B65D 88/54; B67D 5/40

(52) U.S. Cl. 222/334; 222/340; 222/380

(57) ABSTRACT

A liquid dispensing device for dispensing predetermined small quantities of liquid during each operating cycle. The dispensing device includes a body having a main liquid passage section that defines a liquid dispensing chamber with a liquid inlet port communicating through a side wall of the passage section and a stop surface at a downstream end of the passage section. A liquid dispensing stem having an annular sealing member about the stem is mounted for movement between retracted and liquid dispensing positions for dispensing a controlled small quantity of liquid, such as 0.10 mm or less, determined by the size of the liquid dispensing chamber less the displacement volume of the stem downstream of the sealing member.

### CROSS-REFERENCE TO RELATED APPLICATIONS

This patent application claims the benefit of U.S. Provisional Patent Application No. 60/735,497, filed Nov. 10, 2005.

### FIELD OF THE INVENTION

The present invention relates generally to spray guns, and more particularly, to spray guns for dispensing relatively small, precisely controlled, quantities of liquid.

### BACKGROUND OF THE INVENTION

Spray guns are known for dispensing substantially uniform quantities of liquid during each operating cycle. The quantity of liquid dispensed in each cycle, however, is not identical. Normal manufacturing tolerances and other imprecisions in the gun design can result in significant variations in the liquid quantities dispensed during each operating cycle. In a spray gun designed to dispense 1 ml. of liquid during each cycle of operation, for example, variances of 0.1 ml and more frequently occur.

When it is desired to dispense small droplet-sized quantities of liquid, such as 0.1 ml or less, more precise control is required. Heretofore, it has been difficult to reliably dispense such small liquid quantities without expensive precision equipment. Also, by virtue of the small volume of the liquid to be dispensed, it has been difficult to selectively vary or change the volume of dispensed liquid with precision.

### OBJECTS AND SUMMARY OF THE INVENTION

It is an object of the present invention to provide an improved spray gun that is adapted for dispensing precisely controlled, relatively small volumes of liquid during each operating cycle.

Another object is to provide a spray gun as characterized above which can be easily adapted to selectively change the precisely controlled volume of dispensed liquid.

A further object is to provide a spray gun of the above kind that is relatively simple in construction and which lends itself to economical manufacture and use.

Other objects and advantages of the invention will become apparent upon reading the following detailed description and upon reference to the drawings, in which:

### BRIEF DESCRIPTION OF THE DRAWINGS

FIG. 1 is a vertical section of an illustrated spray gun in accordance with the invention, showing the liquid dispensing piston thereof in a retracted liquid receiving position;

FIGS. 2a and 2b are fragmentary sections depicting downward movement of the liquid dispensing piston during a dispensing cycle;

FIG. 3 is an enlarged fragmentary section of the liquid dispensing chamber of the illustrated spray gun;

FIG. 4 is an enlarged fragmentary section depicting the end of the liquid dispensing piston as it enters the dispensing chamber; and

FIG. 4b is a fragmentary section, similar to FIG. 4, depicting the spray gun with an alternative liquid dispensing piston effective for dispensing smaller volumes of liquid during each operating cycle.

While the invention is susceptible of various modifications and alternative constructions, a certain illustrated embodiment thereof has been shown in the drawings and will be described below in detail. In should be understood, however, that there is no intention to limit the invention to the specific form disclosed, but on the contrary, the intention is to cover all modifications, alternative constructions and equivalents falling within the spirit and scope of the invention.

### DETAILED DESCRIPTION OF THE PREFERRED EMBODIMENT

Referring now more particularly to the drawings, there is shown an illustrative spray gun 10 in accordance with the invention which is adapted for dispensing relatively small, precisely controlled volumes of liquid during each operating cycle. The illustrated spray gun 10 includes a two part body 11 comprising upper and lower body members 11a, 11b coupled together by longitudinal bolts 12. The nozzle body 10 has a liquid inlet port 14 coupled to an appropriate liquid supply line 15 which communicates through a relatively small diameter inlet 14a with a main axial liquid passageway or passage section 16 in the nozzle body member 11b, which in turn communicates with a spray tip or discharge orifice member 18 mounted on a downstream end of the body 11. To facilitate aligned assembly of the upper and lower body members 11a, 11b, the upper body member 11a is formed with a depending annular collar 20 for positioning against an annular sealing gasket 20a within an annular recess 21 in the lower body member 11b. The upper body member 11a in this instance also is formed with an upstanding annular nipple 22 to facilitate mounting of the spray gun on a mounting bracket 23 or the like for a particular installation.

The spray tip 18 in this case is mounted on an axial hub 19 of the body member 11b, being retained within a counter-bore 26 of the hub 19. The spray tip 18 has an annular retaining flange which is secured with the hub 19 by a threaded clamping ring 28, with an annular sealing gasket 29 interposed between the flange and spray gun body.

The spray gun body liquid passageway 16 includes a relatively small diameter nozzling section 16a defined in a wall of the body member 11b that communicates with an enlarged passage section 16b. The spray tip 18 has a liquid flow passageway 24 communicating with the body passageway 16 defined by a large diameter inlet section 24a and a smaller diameter nozzling passage 24b extending through a protruding nose 25 of the spray tip 18.

In accordance with the invention, the spray gun has a cyclically operable liquid dispensing piston arrangement adapted for dispensing a precisely controlled predetermined small quantity of liquid during each cycle of operation of the spray gun. To this end, the illustrated spray gun 10 includes a liquid dispensing piston 30 supported for axial reciprocating movement within the nozzle body 11. The liquid dispensing piston 30 in this instance has an enlarge diameter piston head 31 disposed within a cylindrical counter-bore 32 of the upper body member 11a and a smaller diameter dispensing stem 34 disposed within the liquid passageway 16 of the lower body member 11b. For biasing the piston 30 in a downstream liquid dispensing direction, a coil spring 35 is disposed about the piston head 31 in interposed relation between an upper end of the counter-bore 32 and an outwardly extending radial flange 36 of the piston head 31.

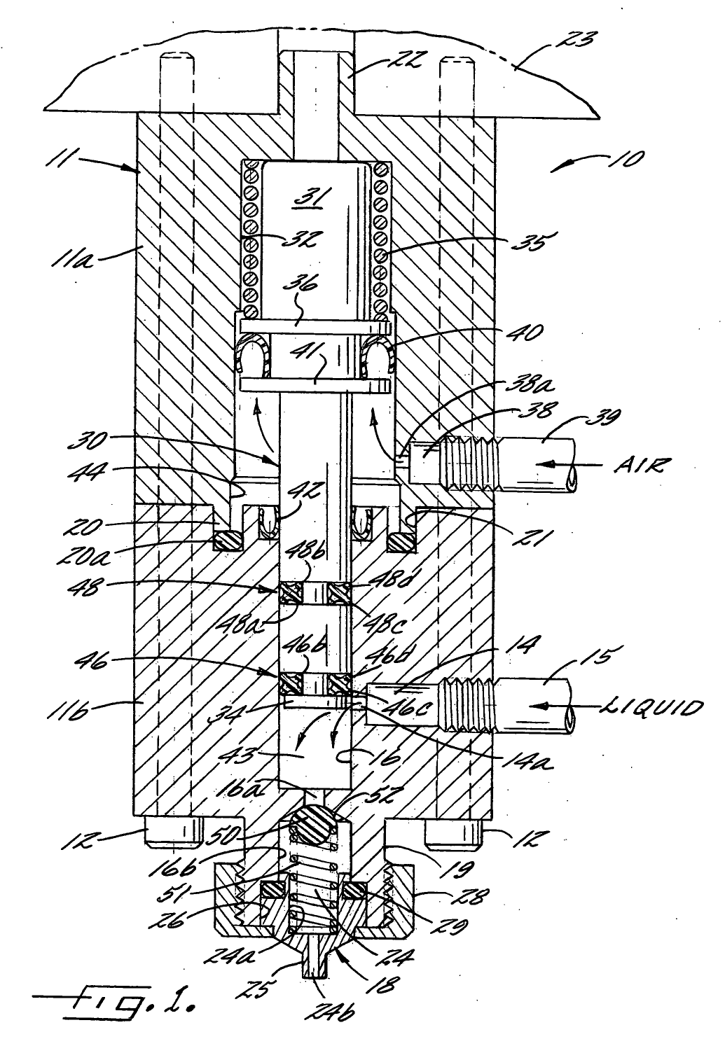

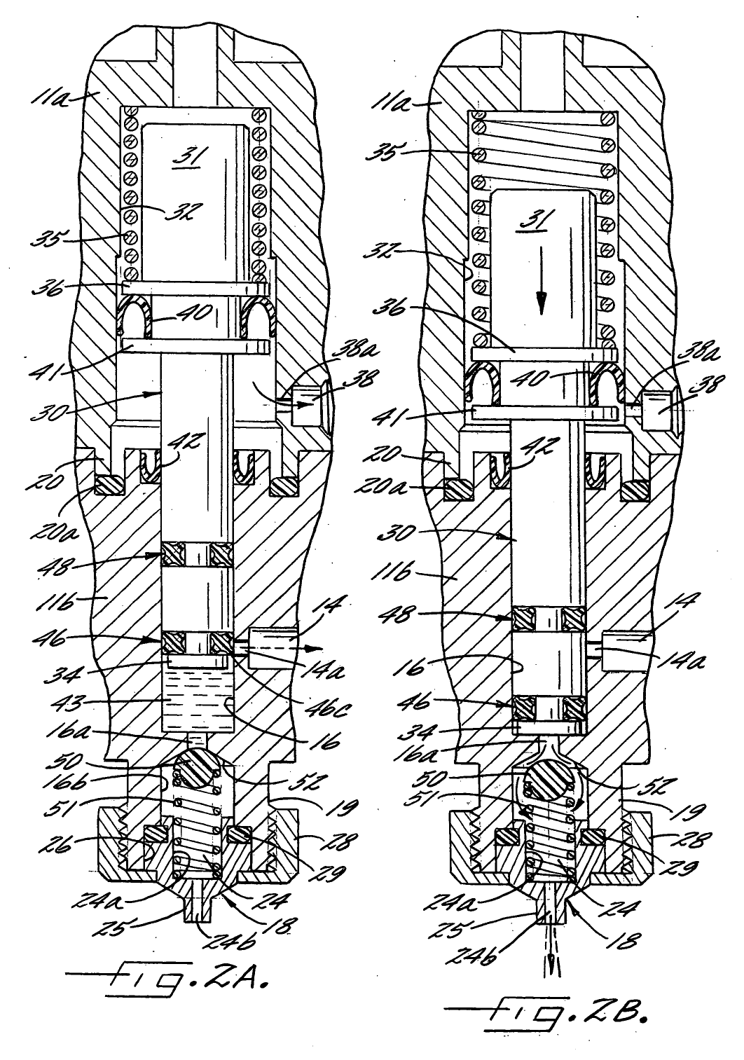

For retracting the piston 30 and liquid dispensing stem 34 thereof in an upstream direction against the force of the biasing spring 35, the nozzle body member 11b is formed with an air inlet port 38 for coupling to a suitable pressurized air supply line 39, which communicates through with a smaller diameter inlet 38a with a lower or downstream side of the piston head 31. To seal the piston head 31 within the counter-bore 32, an annular U-cup seal 40 is retained within a channel defined between axially spaced flanges 36, 41 of the piston head 31. The U-cup seal 40 is mounted such that an air pressure receiving pocket defined by the seal is oriented on an underside thereof. A second U-cup seal 42 in this case is disposed about an upstream of the liquid dispensing stem 34 adjacent a smaller diameter wall opening 44 of the spray gun body through which the stem extends. Hence, pressurized air directed through the air inlet port 38 communicates with a lower side of the piston head 31 and cup seal 40 for moving the piston 30 in an upstream direction against the force of the biasing spring 35 (as shown in FIG. 1).

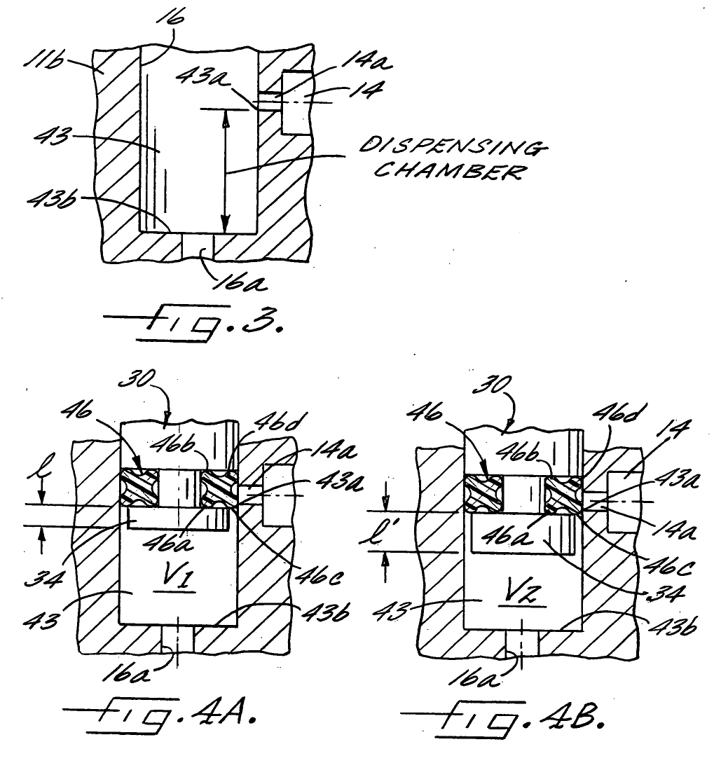

In carrying out the invention, the spray gun body passage 16 defines a predetermined size liquid dispensing chamber 43 (FIG. 3) downstream of the liquid inlet 14a and the liquid dispensing stem 34 of the piston 30 is sized and designed for causing precisely controlled predetermined small quantities of liquid to be dispersed during each reciprocating cycle of the piston 30. In this case, a liquid dispensing chamber 43 has a precise predetermined volume defined between a downstream side 43a of the liquid inlet 14a and an end wall or stop surface 43b of the body member 11b, and the liquid dispensing piston stem 34 is provided with a pair of annular sealing rings 46, 48 in predetermined spaced relation to a downstream end of the stem 34, dependent upon the quantity of liquid to be dispensed during each operating cycle of the spray gun. The illustrated seals 46, 48 are quad seals of a commercially available type, which each have four annular sealing nibs 46a-d, 48a-d, with two radially inward nibs 46a, b and 48a, b of each seal being disposed in axially spaced sealing contact with the liquid dispensing stem 34 and the two radially outward nibs 46c, d, 48c, d being disposed in axially spaced sealing contact with a wall of the liquid passageway 16. The downstream outer nib 46c of the spray gun body quad seal 46 in this instance is disposed in predetermined spaced relation to the downstream lower end of the liquid dispensing stem 34 for controlling the quantity of liquid to be dispensed in an operating cycle, and the upstream quad seal 48 is disposed so as to be upstream of the liquid inlet 14a during both retraced and extended positions of the piston 30.

For preventing liquid downstream of the nozzling liquid passage section 16a from being drawn back into the liquid passage 16 during retraction of the piston 30, a rubber check valve 50 is provided on a downstream side of the nozzling passage section 16a, which is biased into a closing position by a spring 51 interposed between the check valve 50 and a downstream end of the spray tip inlet passage section 24. To facilitate proper positioning of the check valve 50 in its closed position, the spray gun body is formed with a tapered seating section 52 on a downstream side of the passage section 16a.

In operation of the spray gun, introducing pressurized air to the air inlet port 38 will cause retracting movement of the piston head 31 and stem 34 upwardly against the biasing force of the spring 35, relieving pressure within the downstream dispensing chamber 34 and enabling the check valve 50 to be biased into a closed position to prevent liquid downstream of the nozzling passage section 16a from being drawn back into the dispensing chamber 43. As the lower quad sealing ring 46 moves upwardly past the liquid inlet 14a, continued upward movement of the piston 30 will create a suction within the dispensing chamber 43 drawing liquid into the liquid passage 16 from the liquid inlet port 14. Termination of pressurized air to the air inlet port 39 will relieve pressure on the underside of the piston head 31, with the resultant downward movement of the piston head 31 and stem 34 under the biasing force of the spring 35. As the lower quad ring 46 of the stem 34 moves toward the liquid inlet 14a excess liquid in the chamber will be forced back through the inlet port 14. Upon the lower nib lobe 46c of the quad seal ring 46 moving downwardly past the downstream side 43a of the inlet 14a, the dispensing chamber 43 is thereupon sealed with a predetermined quantity of liquid to be dispensed. With the piston biasing spring 35 being significantly stronger than the check valve biasing spring 51, the piston biasing spring 35 will continue to force the piston stem 34 downwardly into the dispensing chamber 43 forcing the liquid to open the check valve 50 and dispense the liquid through the spray tip. When the piston stem 34 bottoms out against the end wall 43b of the dispensing chamber 43, a relatively precise, predetermined quantity of liquid, measured by the volume of the dispensing chamber, less the displacement volume of the stem 34 downstream of the quad seal lower nib 46c, will have been dispensed.

It will be appreciated by one skilled in the art that the dispensing gun 10 is relatively simple in construction and operation, while enabling precise control in the volume of the dispensed liquid during each operating cycle. In this regard, the volume of liquid dispensed is not dependent upon the length of retracting movement of the piston 30 in a upstream direction. The piston 30 need only be retracted sufficiently to fill the liquid passage 16 downstream of the lower quad sealing ring 46. Any excess quantity of liquid drawn into the spray gun 10 during retraction of the piston 30 is simply forced back out the liquid inlet port 14 during downward dispensing movement of the piston 30 until such time as the quad seal lower nib 46c passes the inlet port 14a. On the other hand, the volume of dispensed liquid can be precisely controlled by the size, and hence displacement volume of the stem 34 downstream of the lower quad ring nib 46c. In other words, since the volume of the displacement chamber 43 downstream of the liquid inlet 14a is constant, precise design in the length “l” of the stem downstream of the lower quad seal nib 46c will enable precise control in the volume of liquid dispensed during a cycle of operation. Hence, it can be seen that the volume of dispensed liquid is precisely determinable by the volume of the liquid dispensing chamber 43 downstream of the liquid inlet 14a, less the displacement volume of the stem section “l” downstream of the lower quad ring nib 46c. Since the nib 46c is relatively small in diameter, in relation to the overall size of the quad sealing ring 46, the displacement volume is precisely established. In practice, cyclic dispensing of liquid droplets as small as 0.05 mm can be accurately and cyclically dispensed.

In carrying out a further feature of the invention, the spray gun 10 can be easily adapted for changing the volume of the dispensed liquid by simply changing the dispensing piston 30. To this end, upon unscrewing the fastening screws 12, the body parts 11a, 11b may be separated, and the piston 30 removed from the body and replaced with a piston 30 having a stem of a different length “l” downstream of the quad seal lower nib 46c. For example, replacement of the piston 30 with a piston having a longer stem length “l” downstream of the lower quad seal nib 46c, and hence a larger liquid displacement volume, will cause a predetermined lesser quantity of liquid to be dispensed during each operating cycle of the spray gun. Likewise, replacing the piston 30 with a piston having a stem 34 with a shorter length “l”, and hence a smaller liquid displacement volume, will result in a predetermined larger quantity of liquid to be dispensed during each operating cycle.

From the foregoing, it can be seen that the spray gun of the present invention is adapted for dispensing precisely controlled relatively small volumes of liquid during each operating cycle. The spray gun also is relatively simple in construction, lends itself to economical manufacture and reliable operation, and can be easily altered to change the volume of dispensed liquid.

1. A liquid dispensing device for dispensing pre-determined small quantities of liquid comprising:
a body having a main liquid passage section,
said body having a liquid inlet port communicating through a side wall of said main liquid passage section for connection with a liquid supply,
a stop surface at a downstream end of said main passage section,
a liquid dispensing stem mounted for reciprocating movement within said main passage section,
a first annular sealing member about said stem for movement with said liquid dispensing stem in sealing contact with the side wall of said main passage section,
said main passage section defining a predetermined sized liquid dispensing chamber between a downstream edge of said inlet port and said stop surface, and
said dispensing stem being movable between a retracted position with said first sealing member upstream of said inlet port for enabling liquid to be drawn into said dispensing chamber and a liquid dispensing position in engagement with said stop surface whereby said first sealing member is moved downstream of said inlet port a predetermined distance for discharging a controlled small quantity of liquid determined by the size of the liquid dispensing chamber less the displacement volume of the stem downstream of a most downstream point of contact of said first sealing member with the side wall of said main liquid passage.

2. The liquid dispensing device of claim 1 including a second annular sealing member disposed about said stem in axially upstream relation to said first sealing member for movement with said stem in sealing contact with said main passage section, said second sealing member remaining in sealing contact with said main passage section upstream of said inlet port during movement of said stem between said retracted and dispensing positions.

3. The liquid dispensing device of claim 1 in which said main passage section communicates with a smaller diameter dispensing passage communicating through said stop surface.

4. The liquid dispensing device of claim 2 including a liquid dispensing discharge orifice member mounted downstream of said smaller diameter passage for dispensing said predetermined small quantity of liquid from said dispensing device during movement of said dispensing stem to said dispensing position.

5. The liquid dispensing device of claim 4 including a check valve disposed between said smaller diameter passage and said liquid dispensing discharge orifice for preventing the flow of liquid upstream through said smaller diameter passage during return movement of said dispensing stem from said dispensing position to said retracted position.

6. The liquid dispensing device of claim 1 in which said dispensing stem has a piston head at an upstream end thereof, a piston head biasing spring for biasing said piston head and liquid dispensing stem to said liquid dispensing position against said stop surface, and air inlet port for coupling to a pressurized air supply communicating with a sealed chamber about a downstream end of said piston head into which pressurized air may be selectively directed for moving said piston head and valve stream to said retracted position against the biasing force of said spring.

7. The liquid dispensing device of claim 6 including a liquid dispensing discharge orifice member mounted downstream of said smaller diameter passage for dispensing said predetermined small quantity of liquid from said dispensing device during movement of said dispensing stem to said dispensing position, a check valve disposed between said smaller diameter passage and said liquid dispensing discharge orifice for preventing the flow of liquid upstream through said smaller diameter passage during return movement of said dispensing stem from said dispensing position to said retracted position, a check valve biasing spring for biasing said check valve toward a liquid dispensing discharge orifice closing position, and said biasing spring for said piston head having a greater strength than said check valve biasing spring.

8. The liquid dispensing device of claim 1 in which said predetermined small quantity of liquid dispensed during movement of said dispensing stem between said retracted and dispensing positions is no greater than 0.10 mm.

9. The liquid dispensing device of claim 1 in which said predetermined small quantity of liquid dispensed during movement of said dispensing stem between said retracted and dispensing positions is no greater than 0.05 mm.

10. The liquid dispensing device of claim 1 in which said first sealing member is a quad-seal having four annular sealing nibs, two of which are in axially-spaced sealing contact with said stem and two of which are in axially-spaced sealing contact with the side wall of said main passage section, one of said sealing nibs in contact with the side wall of said main passage section being downstream of the other nib in contact with said side wall, and said predetermined small quantity of liquid being determined by the size of the liquid dispensing chamber less than the displacement volume of the stem downstream of the point of sealing contact of the downstream sealing nib of the quad-seal with the side wall of the main passage section.

11. The liquid dispensing device of claim 10 including a second quad-seal having two axially-spaced sealing nibs in contact with said stem and two axially-spaced nibs in sealing contact with the side wall of said main passage section, said second quad-seal remaining in sealing contact with said main passage section upstream of said inlet port during movement of said stem between said retracted and dispensing positions.

12. The liquid dispensing device of claim 1 in which said dispensing stem is removable from said valve body, and including a replacement liquid dispensing stem mountable in said body having an annular sealing member disposed about the replacement stem at an axial distance from a downstream end different from the axial distance of the first sealing member from the downstream end of the removable stem for dispensing a different predetermined small quantity of liquid during movement of the replaceable stem between retracted and liquid dispensing positions with the annular sealing member of said second stem in contact stem in contact with the side wall of said main passage section.

13. The liquid dispensing device of claim 12 in which said removable and replacement liquid dispensing stems each have a respective piston head at an upstream end thereof, and said removable liquid dispensing stem and respective piston head being removable and replaceable by said replacement liquid dispensing stem and respective piston head.

14. A liquid dispensing device for dispensing pre-determined small quantities of liquid comprising:
a body having a main liquid passage section,
said body having a liquid inlet port communicating through a side wall of said main liquid passage section for connection with a liquid supply,
a stop surface at a downstream end of said main passage section,
a first liquid dispensing stem mounted for reciprocating movement within said main passage section,
a first annular sealing member about said first stem at a first predetermined axial distance from the downstream end of said first stem for movement with said liquid dispensing stem in sealing contact with the side wall of said main passage section,
said main passage section defining a predetermined sized liquid dispensing chamber between a downstream edge of said inlet port and said stop surface,
said first dispensing stem being movable between a retracted position with said first sealing member upstream of said inlet port for enabling liquid to be drawn into said dispensing chamber and a liquid dispensing position in engagement with said stop surface whereby said first sealing member is moved downstream of said inlet port for discharging a predetermined small quantity of liquid determined by the size of the liquid dispensing chamber less the displacement volume of the first stem downstream of a most downstream point of contact of said first sealing member with the side wall of said main liquid passage,
a second liquid dispensing stem having an annular sealing member about said stem at a second axial distance from a downstream end thereof different from said first axial distance, and said first liquid dispensing stem being removable from said body and replaceable by said second liquid dispensing stem for dispensing a different predetermined small quantity of liquid determined by the size of the liquid dispensing chamber less than the displacement volume of the second stem downstream of a most downstream point of contact of the sealing member of said second stem with the sidewall of said main liquid passage section.

15. A method of changing the predetermined small quantity of liquid dispensed during each cycle of a liquid dispensing device having a main passage section with a stop surface at a downstream end thereof and a removable liquid dispensing stem mounted for reciprocating movement within said main passage section and having a first annular sealing member mounted at a first predetermined axial distance from a downstream end of the stem for movement in sealing contact with a sidewall of the main passage section comprising the steps of removing said removable stem from the spray device body, and replacing the said removable stem with a second stem having a sealing member disposed at a second predetermined axial distance from a downstream end of the second stem different from said first predetermined axial distance.

16. The method of claim 20 including replacing said removable liquid dispensing stem with a second liquid dispensing stem having a sealing member located a longer axial distance from the downstream end of the dispensing stem than said first predetermined axial distance for dispensing a smaller quantity of liquid during an operating cycle.

17. The method of claim 20 including replacing and removable liquid dispensing stem with a second liquid dispensing stem having a sealing member located a shorter axial distance from the downstream end of the dispensing stem than said first predetermined axial distance for dispensing a larger quantity of liquid during an operating cycle.
